(19) United States
(12) Patent Application Publication
(10) Pub. No.: US 2013/0198282 A1
(43) Pub. Date: Aug. 1, 2013

(54) APPARATUS AND METHOD FOR PROVIDING SOCIAL MAGAZINE INFORMATION

(71) Applicants: Hoon-Ki LEE, Daejeon (KR); Jong-Hoon LEE, Daejeon (KR); Jung-Tae KIM, Daejeon (KR)

(72) Inventors: Hoon-Ki LEE, Daejeon (KR); Jong-Hoon LEE, Daejeon (KR); Jung-Tae KIM, Daejeon (KR)

(73) Assignee: ELECTRONICS AND TELECOMMUNICATIONS RESEARCH INSTITUTE, Daejeon (KR)

(21) Appl. No.: 13/563,049

(22) Filed: Jul. 31, 2012

(30) Foreign Application Priority Data
Jan. 30, 2012 (KR) 10-2012-0009141

(51) Int. Cl. G06F 15/16

(52) U.S. Cl. 709/204

(57) ABSTRACT

Disclosed herein is an apparatus and method for providing social magazine information. The method is configured such that an apparatus operating in conjunction with at least one user terminal provides social magazine information to a corresponding user terminal. In the method, a social magazine is dynamically reconstructed according to a context of a user of each user terminal. Customized information corresponding to the user terminal is provided based on the reconstructed social magazine. A community is formed among user terminals which share the reconstructed social magazine, and social magazine information is shared through the formed community.

### CROSS REFERENCE TO RELATED APPLICATION

This application claims the benefit of Korean Patent Application No. 10-2012-0009141, filed on Jan. 30, 2012, which is hereby incorporated by reference in its entirety into this application.

### BACKGROUND OF THE INVENTION

1. Technical Field

The present invention relates generally to an apparatus and method for providing social magazine information. More particularly, the present invention relates to an apparatus and method for providing social magazine information, which provides social magazine information for users located in a movement space having specific mobility in a social network service environment.

2. Description of the Related Art

When advertisement information is provided regardless of the personal characteristics of users, the users are provided with unilateral one-off advertisement-centered information. That is, there is a disadvantage in that users provided with advertisement information regardless of their personal characteristics receive unnecessary information. Therefore, users desire to be provided with information closely related to them, that is, user-customized information. For example, in a place where a user is located, the range of information provision to several spaces in the place needs to be changed to suit the user.

Users corresponding to a moving object (for example, an airplane, a train, a bus, etc.) in which the location information can change without changing the space (location mobility), or users corresponding to a movement space (for example, a department store, a mass market, etc.) in which an internal space can change without changing location (space mobility), receive magazine information that is provided periodically (for example, at 1-month intervals). In this case, there is a disadvantage in that it is difficult to dynamically change the magazine information and only the same information is provided to all users. Further, since magazine information is periodically provided to users in the form of a magazine, the cost of printing must be paid.

Recently, in an actual environment in which the number of smartphone users rapidly increases, there is a need to change an information transfer method from a conventional magazine-type information transfer method to a space-oriented social magazine information transfer method based on smart terminals by using mobile terminals. Further, users present in a single movement space may have a similar purpose or similar needs even if they have no social relationship.

In this way, such a conventional push-type information transfer method requires a social magazine information provision service in which various types of information are dynamically configured depending on time, space or purpose and the dynamically configured information is provided in the form of a Social Network Service (SNS).

### SUMMARY OF THE INVENTION

Accordingly, the present invention has been made keeping in mind the above problems occurring in the prior art, and an object of the present invention is to provide social magazine information for users located in a movement space having specific mobility in a social network service environment.

Another object of the present invention is to allow a space-oriented social magazine having users' locations and mobility to be shared via a social network service.

A further object of the present invention is to provide a method of sharing various types of customized social magazine information by forming a community among users present in a space having mobility.

Yet another object of the present invention is to provide a management system and a method of operating the system, which provide customized information based on the location at which a user is present and detailed mobility-based space information, and allow an immediate and space-oriented community to be formed via the formation of a community among various users present in this space, unlike a conventional scheme in which information provision services such as a social magazine unilaterally provide information.

Still another object of the present invention is to vary methods of providing social magazine information based on contextual information as in the case where location information changes without changing the space information such as in a train/bus/airplane, and in the case where space information changes without greatly changing location information such as in a department store/mass market/shopping mall, thus enabling various types of information to be differently provided to users located in a single space.

In accordance with an aspect of the present invention to accomplish the above objects, there is provided a method of providing social magazine information, the method being configured such that an apparatus operating in conjunction with at least one user terminal provides social magazine information to a corresponding user terminal, the method including dynamically reconstructing a social magazine according to a context of a user of each user terminal; providing customized information corresponding to the user terminal based on the reconstructed social magazine; and forming a community among user terminals which share the reconstructed social magazine, and sharing social magazine information through the formed community.

Preferably, the social magazine may correspond to information transfer means that is provided to users depending on a location and a space.

Preferably, the dynamically reconstructing the social magazine may include determining a domain corresponding to a service that is to be provided to the user; determining whether the determined domain corresponds to location mobility or space mobility; construct a classification system for location mobility or space mobility based on results of the determination of whether the domain corresponds to location mobility or space mobility; configuring profiles for respective classes based on the classification system; and examining the configured profiles using a preset examination procedure, and determining whether to reconstruct the classification system based on results of the examination.

Preferably, the constructing the classification system may include forming a classification system for location mobility based on latitude and longitude using a Global Positioning System (GPS) by subdividing an area depending on latitude and longitude, or forming a classification system for location mobility based on addresses such as in area boundaries; and forming a classification system for space mobility based on a purpose of a movement space.

Preferably, the profiles may correspond to information that is provided to the corresponding user terminal via the social magazine and include components extracted depending on a location and a space.

Preferably, the providing the customized information may include collecting a location of the user and domain information corresponding to the location of the user; analyzing information denoted by a current location based on the location of the user and the domain information; extracting profile information of the user and a classification system for location mobility or space mobility based on results of the analysis of the information denoted by the current location, and analyzing results of the extraction; extracting social magazine information based on the results of the analysis, and processing the extracted social magazine information in a required format; and revising the processed social magazine information in accordance with characteristics of the corresponding user terminal.

Preferably, the providing the customized information may include determining events and notification information, such as notice messages, in addition to the social magazine information, and configuring the determined notification information in a format of push-type information; and outputting the push-type information and the social magazine information to the user terminal via a web interface.

Preferably, the sharing the social magazine information may include determining an area for a location and a space corresponding to a domain of the user terminal connected to the apparatus; determining whether a community is present in the area for the location and the space; and selecting a method of sharing the social magazine information depending on results of the determination of whether the community is present.

Preferably, the selecting the method of sharing the social magazine information may include if the community is present, registering the user of the terminal connected to the apparatus as a member of the community; activating services among users in a social network formed by registering the user as the member of the community; sharing information, which is shared by activating the services among the users in the social network, via a temporary storage unit; and exchanging the social magazine information among the users via the temporary storage unit.

Preferably, the selecting the method of sharing the social magazine information may include if a community is not present, initially constructing a community; determining whether to activate the initially constructed community; if a specific storage unit is required upon activating the community, exchanging the social magazine information among the users via the specific storage unit; and if the specific storage unit is not required upon activating the community, waiting for the user terminal of the user to access the community.

In accordance with another aspect of the present invention to accomplish the above objects, there is provided an apparatus for providing social magazine information, including a social magazine operation unit for operating a social magazine corresponding to information transfer means that is provided to each user depending on a location and a space; a dynamic magazine reconstruction management unit for dynamically reconstructing the social magazine according to a context of a user terminal held by the user; and a user relation information management unit for providing customized information corresponding to the user terminal based on the reconstructed social magazine or forming a community among user terminals who share the reconstructed social magazine, and sharing the social magazine information through the formed community.

Preferably, the social magazine operation unit may include a user interface reconstruction unit for reconstructing user interfaces corresponding to characteristics of user terminals held by respective users; a web server engine unit for setting methods of connecting to the respective user terminals; a user information management unit for managing pieces of user information corresponding to the user terminals; a community management unit for extracting sociality among the user terminals, and forming and managing communities with the users through a community corresponding to the extracted sociality; and a shared information management unit for supporting shared information transfer methods by which the respective users are capable of transferring their desired information using the communities.

Preferably, each of the user terminals may be means provided with a social network service and include feature elements related to hardware specifications.

Preferably, the dynamic magazine reconstruction management unit may include a storage unit for storing the social magazine information; an extraction unit for extracting information about a service that is to be provided to each user based on location information, space information, and profile information corresponding to at least one of pieces of user information; a processing unit for processing extracted service information in a format corresponding to the user terminal; an editing unit for reconstructing processed service information in conformity with characteristics of the user terminal, and then generating the dynamic magazine information; and a management unit for analyzing the dynamic magazine information and determining a service method to be subsequently provided, in relation to a context in which the dynamic magazine information is to be provided, based on results of the analysis.

Preferably, the user relation information management unit may include a user profile management unit for managing profiles of the user corresponding to the user terminal; an information management unit for managing location and space information of the user corresponding to the user terminal in real time; a social network construction unit for constructing network elements required to transfer information among users in the community; and a dynamic community processing unit for performing control so that pieces of information provided through the community are shared via participation of the users in the community.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing an apparatus for providing social magazine information according to an embodiment of the present invention;

FIGS. 2 and 3 are diagrams showing the detailed configuration of the social magazine information provision apparatus according to an embodiment of the present invention;

FIG. 4 is a flowchart showing a method of providing social magazine information according to an embodiment of the present invention;

FIG. 5 is a flowchart showing a method of reconstructing a social magazine according to an embodiment of the present invention;

FIG. 6 is a flowchart showing a method of constructing a social magazine in the procedure of providing customized information according to an embodiment of the present invention;

FIG. 7 is a flowchart showing a method in which a user terminal is provided with social magazine information in the procedure of providing customized information according to an embodiment of the present invention; and

FIG. 8 is a flowchart showing a method of forming a community and sharing social magazine information through the community according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, an apparatus and method for providing social magazine information according to embodiments of the present invention will be described in detail with reference to the attached drawings.

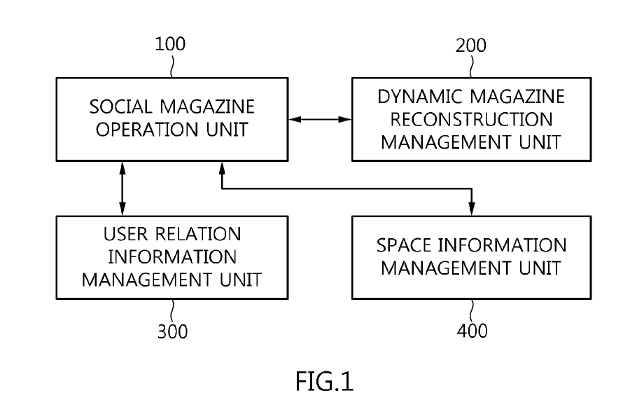

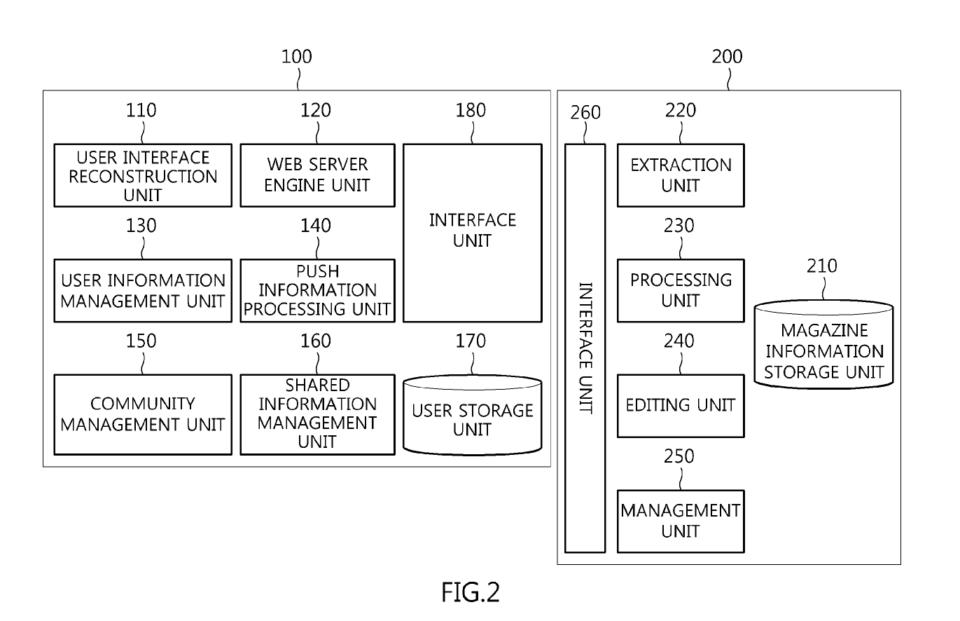

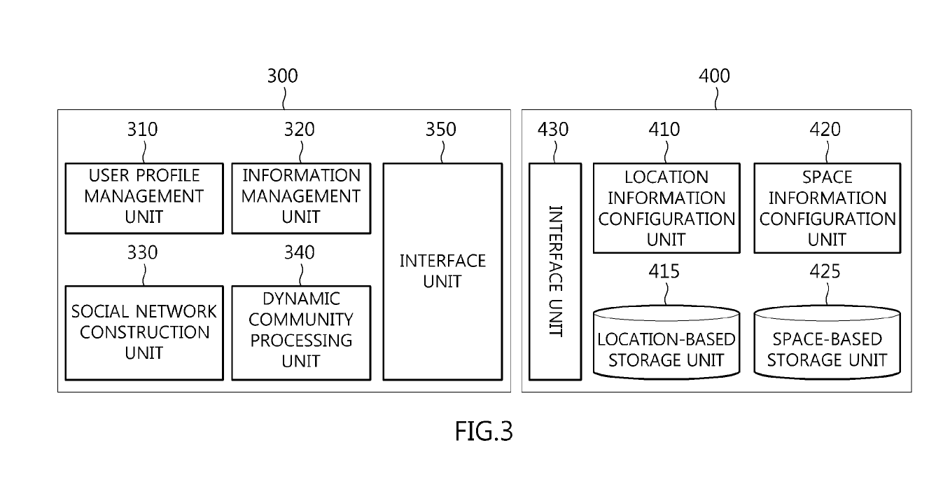

FIG. 1 is a diagram schematically showing an apparatus for providing social magazine information according to an embodiment of the present invention. FIGS. 2 and 3 are diagrams showing the detailed configuration of the social magazine information provision apparatus according to an embodiment of the present invention.

Referring to FIG. 1, the social magazine information provision apparatus includes a social magazine operation unit 100, a dynamic magazine reconstruction management unit 200, a user relation information management unit 300, and a space information management unit 400.

The social magazine operation unit 100 operates a social magazine corresponding to an information transfer means that is provided to each user depending on the location and the space.

Referring to FIG. 2, the social magazine operation unit 100 includes a user interface reconstruction unit 110, a web server engine unit 120, a user information management unit 130, a push information processing unit 140, a community management unit 150, a shared information management unit 160, a user storage unit 170, and an interface unit 180.

The user interface reconstruction unit 110 reconstructs User Interfaces (UI) corresponding to the characteristics of terminals held by respective users (hereinafter referred to as “user terminals”). Here, such a user terminal is a means provided with a social network service and includes feature elements related to hardware specifications of the terminal.

The web server engine unit 120 sets methods of connecting to the respective user terminals. The web server engine unit 120 is connected to a plurality of user terminals based on the corresponding connection methods that have been set for the user terminals. In this case, the web server engine unit 120 operates in conjunction with a distribution server for a web server (not shown) when connecting to the plurality of user terminals, thus providing similar service qualities to the plurality of users.

The user information management unit 130 manages pieces of information about users corresponding to respective user terminals (hereinafter referred to as “user information”).

The push information processing unit 140 is configured to, in the case where the user terminals share specific information, provide an event occurring when having to notify users of information sharing to the users via the user terminals.

The community management unit 150 extracts sociality among the user terminals and forms and manages communities with the plurality of users through a community corresponding to the extracted sociality.

The shared information management unit 160 supports a shared information transfer method allowing each individual user to transfer the desired information using the communities. For example, the shared information transfer method includes video calls, text messaging, file transmission, etc.

The user storage unit 170 temporarily stores user-shared information that is shared among the plurality of users through the communities. The user storage unit 170 can overcome inconveniences caused by the storage spaces of user terminals.

The components (not shown) for collecting location information about each user, or connecting networks among user terminals may be present in various forms according to the environment to which the social magazine information provision apparatus is applied. Here, various types of application environments, such as the movement of a domain at a fixed location and a fixed domain at a moving location, may include a plurality of contexts (situations), such as a method of communicating with a specific server and the construction of a network between user terminals.

The interface unit 180 interfaces with the dynamic magazine reconstruction management unit 200, the user relation information management unit 300, and the space information management unit 400. For this, the interface unit 180 includes a magazine reconstruction interface, a user relation information interface, and a space information management interface.

The dynamic magazine reconstruction management unit 200 constructs a magazine that is provided based on location information, space information and each user's profile. For this, the dynamic magazine reconstruction management unit 200 includes a magazine information storage unit 210, an extraction unit 220, a processing unit 230, an editing unit 240, a management unit 250, and an interface unit 260.

The magazine information storage unit 210 stores magazine information that is provided via a magazine, for example, periodic information transfer media such as news items/manuscripts, local advertisements for an advertising service, multimedia shared among the user terminals, and event information provided at respective times and places. The magazine information storage unit 210 can provide the latest information to the users by updating and managing the magazine information in real time.

The extraction unit 220 extracts information about a service to be provided to the users based on location information, space information, and profile information corresponding to user information or the like.

For example, the extraction unit 220 reconstructs extracted patterns based on the behavioral patterns of the users, so that more advanced service information can be provided when the same context occurs.

The processing unit 230 processes the extracted service information in a format corresponding to the user terminals.

The editing unit 240 reconstructs the processed service information in conformity with the characteristics of the user terminals, and then generates dynamic magazine information.

The management unit 250 analyzes the dynamic magazine information, and determines a service method to be subsequently provided in relation to the context in which the magazine information is to be provided, on the basis of the results of the analysis.

The interface unit 260 performs an interface function capable of basically supporting an Application Programming Interface (API) via an external interface so as to prevent the dynamic magazine reconstruction management unit from being subordinate to a specific operating system. Further, the interface unit 260 interfaces with the social magazine operation unit 100.

The user relation information management unit 300 manages users corresponding to user terminals which are connected to the social magazine information provision apparatus, and manages information about relations between users configured in communities.

Referring to FIG. 3, the user relation information management unit 300 includes a user profile management unit 310, an information management unit 320, a social network construction unit 330, a dynamic community processing unit 340, and an interface unit 350.

The user profile management unit 310 manages the profiles of users corresponding to the user terminals which are connected to the social magazine information provision apparatus.

The information management unit 320 manages information about the locations and spaces of users corresponding to the user terminals, which are connected to the social magazine information provision apparatus, in real time.

The social network construction unit 330 constructs network-related components required to transfer information among users within each community, thus managing the life cycle of the network while the community is being operated.

The dynamic community processing unit 340 performs control such that pieces of information provided through the communities are shared by the participation of the users in the communities.

The interface unit 350 provides a connection method enabling information to be provided regardless of a specific service domain, and interfaces with the social magazine operation unit 100.

The space information management unit 400 allocates location and space information corresponding to a relevant service domain and manages profiles corresponding to the location and space information.

The space information management unit 400 includes a location information configuration unit 410, a location-based storage unit 415, a space information configuration unit 420, a space-based storage unit 425, and an interface unit 430.

The location information configuration unit 410 classifies location information depending on the purpose of the service provided to the users through the user terminals. Further, the location information configuration unit 410 stores the location information classified depending on the purpose of the service in the location-based storage unit 415.

The space information configuration unit 420 classifies space information depending on the purpose of the service provided to the users through the user terminals. Further, the location information configuration unit 410 stores the space information classified depending on the purpose of the service in the space-based storage unit 425.

The interface unit 430 interfaces with the social magazine operation unit 100.

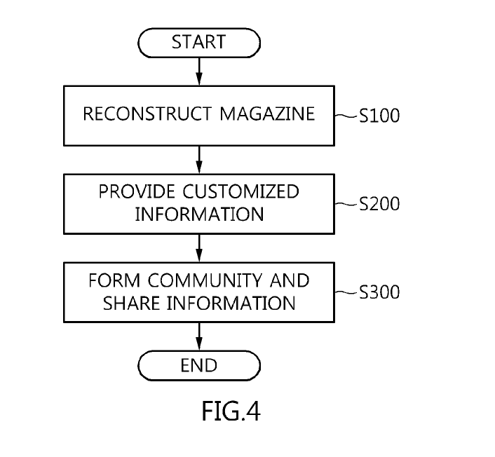

Next, a method of providing social magazine information will be described in detail below with reference to FIG. 4.

FIG. 4 is a flowchart showing a method of providing social magazine information according to an embodiment of the present invention.

Referring to FIG. 4, the social magazine information provision apparatus dynamically reconstructs a social magazine according to the context of each user at step S100.

Next, the social magazine information provision apparatus provides customized information corresponding to each user terminal based on the social magazine, which has been reconstructed at step S100, at step S200. Further, the social magazine information provision apparatus forms a community among user terminals which share the social magazine reconstructed at step S100, and allows the users to share the information of the social magazine through the formed community at step S300.

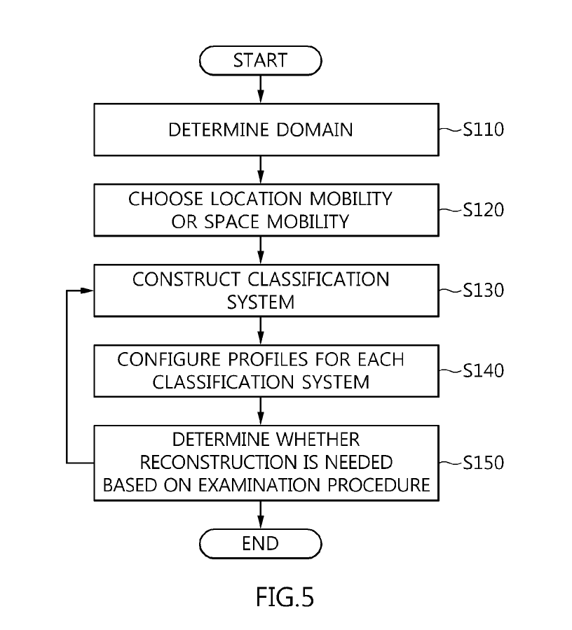

Next, the step S100 of reconstructing the social magazine will be described in detail with reference to FIG. 5.

FIG. 5 is a flowchart showing a method of reconstructing a social magazine according to an embodiment of the present invention.

Referring to FIG. 5, the social magazine information provision apparatus determines a domain to which a service is to be provided at step S110. In detail, the social magazine information provision apparatus determines a domain corresponding to users who correspond to a moving object (e.g., an airplane, a train, a bus, etc.) in which the location information can change without changing the space (location mobility), or users corresponding to a movement space (for example, a department store, a mass market, a shopping mall, etc.) in which an internal space can change without changing location (space mobility).

The social magazine information provision apparatus determines which of location mobility and space mobility is considered to be more important in the determined domain at step S120.

Next, the social magazine information provision apparatus construct a classification system for location mobility or space mobility determined at step S120 at step S130. Here, the social magazine information provision apparatus may form a classification system for location mobility based on latitude and longitude using a Global Positioning System (GPS) by subdividing an area depending on latitude and longitude, or may form a classification system for location mobility based on addresses such as in area boundaries. Further, the social magazine information provision apparatus may form a classification system for space mobility based on the purpose of the movement space (e.g., a department store, a mass market, a shopping mall, etc.).

For example, the social magazine information provision apparatus forms a classification system either by partitioning a space such as that of an airplane or a train having mobility, or based on the preferences of customers with respective to each department store (or each floor) when considering space mobility to be more important.

The social magazine information provision apparatus configures profiles for respective classes, based on the classification system formed at step S130, at step S140. In this case, the profiles correspond to the information that is provided to the user terminals via the social magazine, and include components extracted depending on the location and the space.

The social magazine information provision apparatus examines the configured profiles using a preset examination procedure, and determines whether to reconstruct the classification system based on the results of the examination at step S150. In this case, when there is a need to reconstruct the classification system, the social magazine information provision apparatus repeatedly performs the step S130 of constructing the classification system and the step s140 of configuring profiles for respective classes.

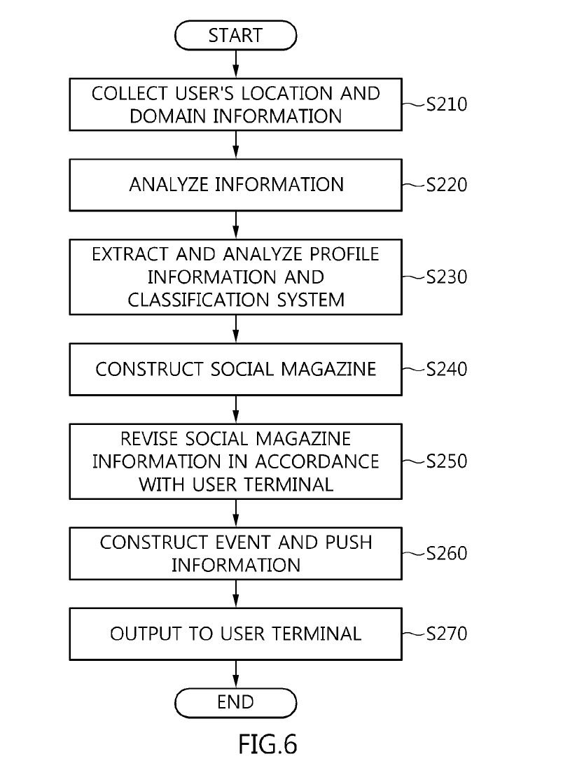

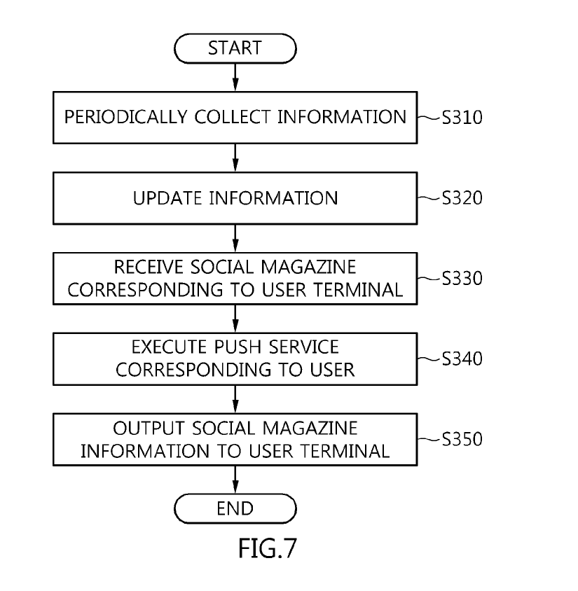

Next, the step S200 of providing the customized information will be described in detail with reference to FIGS. 6 and 7.

FIG. 6 is a flowchart showing a method of constructing a social magazine in the procedure of providing customized information according to an embodiment of the present invention.

The social magazine information provision apparatus collects the location of each user and domain information corresponding to the user's location at step S210.

The social magazine information provision apparatus analyzes information denoted by a current location based on the user's location and the domain information, which have been collected at step S210, at step S220.

The social magazine information provision apparatus analyzes required information such as history information about activity patterns for respective locations of the user at step S220 because social magazine information that is provided changes depending on whether the user is a mobility-oriented user or a location-oriented user.

The social magazine information provision apparatus extracts the profile information of the user and a classification system for location mobility or space mobility based on the results of the analysis, performed at step S220, and analyzes the extracted results at step S230.

The social magazine information provision apparatus extracts social magazine information based on the results of the analysis, performed at step S230, and processes the extracted social magazine information in a required format at step S240.

The social magazine information provision apparatus revises the processed social magazine information in accordance with the characteristics of the user terminal at step S250.

The social magazine information provision apparatus determines events and notification information that must be transferred to the user, such as notice messages, in addition to the social magazine information, and configures the determined notification information in the format of push-type information at step S260.

The social magazine information provision apparatus outputs the push-type information and the social magazine information to the user terminal via a web interface at step S270.

FIG. 7 is a flowchart showing a method in which each user terminal is provided with social magazine information in the procedure of providing customized information according to an embodiment of the present invention.

Referring to FIG. 7, the user terminal periodically collects the location information and the space information of the user at step S310. Step S310 denotes the procedure of collecting information to update magazine information via the movement of the location and space of the user.

At step S320, the user terminal updates information based on the pieces of information collected at step S310. In this case, the user terminal may update information using only the movement of a space among the pieces of information collected at step S310.

The user terminal provides the updated information to the social magazine information provision apparatus, and receives social magazine information corresponding thereto at step S330. In this case, the social magazine information provision apparatus performs the procedure starting from steps S220 to S250 of FIG. 6, and transfers the results of performing the steps S220 to S250, that is, social magazine information, to the user terminal.

The user terminal executes a push service corresponding to the received social magazine information at step S340.

The user terminal obtains the user's agreement via the notification information provided using the executed push service, and outputs the social magazine information to the user at step S350.

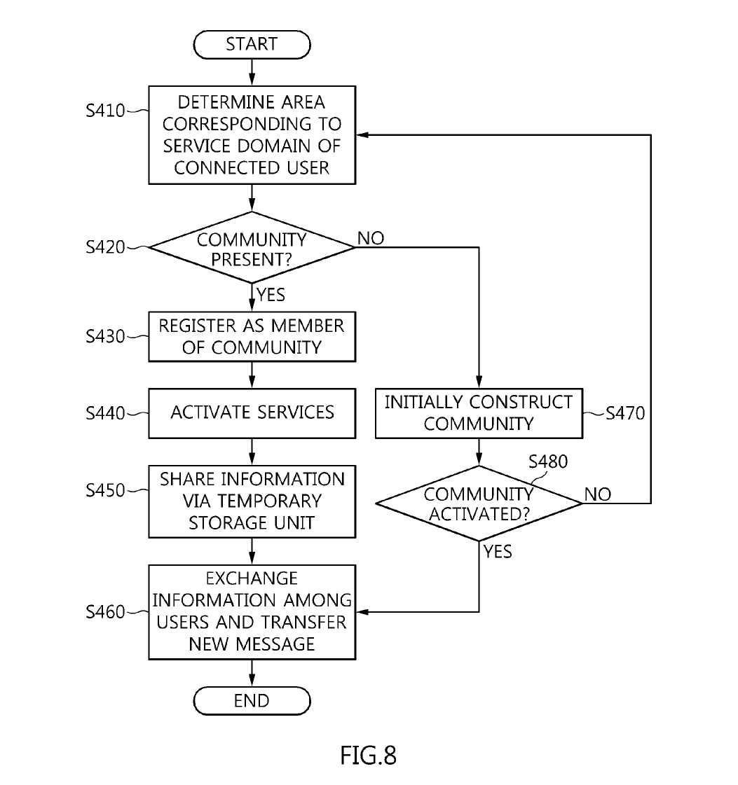

The social magazine is an information transfer means that is provided to users depending on the location and the space. Individual users share social magazine information suitable for them with one another. Next, the step S300 of forming the community among user terminals which share the social magazine and sharing the social magazine information through the formed community will be described in detail with reference to FIG. 8.

FIG. 8 is a flowchart showing a method of forming a community and sharing social magazine information through the formed community according to an embodiment of the present invention.

Referring to FIG. 8, the social magazine information provision apparatus determines an area for the location and the space corresponding to the domain of each user terminal connected to the apparatus at step S410.

The social magazine information provision apparatus determines whether a community is present in the determined area for the location and the space at step S420.

If there is a community, the social magazine information provision apparatus registers the connected user terminal as the member of the community at step S430. In this case, the social magazine information provision apparatus notifies the existing members of the community of the registration of the new member, and reconstructs a social network based on the registration of the new member. This reconstruction of the social network is intended to share profile information required to transfer information and to perform service interaction among the users.

The social magazine information provision apparatus forms the social network at step S430, and activates services among the users in the social network at step S440, so that the services among the users can be operated in conjunction with one another. The services operated among the users include chatting, video calls, content sharing, etc.

The social magazine information provision apparatus shares information, which is shared by activating the services among the users in the social network, via a temporary storage unit at step S450.

The social magazine information provision apparatus exchanges social magazine information among the users through the temporary storage unit, and transfers a new message corresponding to a user who newly participates in the social network to other users at step S460.

Meanwhile, if there is no community, the social magazine information provision apparatus initially constructs a community at step S470.

Next, the social magazine information provision apparatus determines whether to activate the initially constructed community.

The social magazine information provision apparatus preferably activates the community when the number of members of the community is at least two. However, if a specific storage unit, such as the temporary storage unit used when social magazine information is exchanged among the users at step S460, is required, the social magazine information is exchanged among the users via the specific storage unit and a new message corresponding to a user who newly participates in the social network is transferred to other users.

In contrast, if the specific storage unit, such as the temporary storage unit used when social magazine information is exchanged among the users at step S460, is not required, the social magazine information provision apparatus initializes only the community and waits for the user terminal of an additional user to access the community.

According to the embodiments of the present invention, the social magazine information provision apparatus and method are configured to form communities between users and a social magazine, which has been provided by dynamically configuring information provided depending on changes in the location and space of the users, so that various types of information provision/transfer means can be used to construct communities.

Further, in accordance with the embodiments of the present invention, the social magazine information provision apparatus and method can partition even a place that is currently moving into individual unit areas, regardless of whether the place is one in which detailed space mobility is emphasized without changing location information or whether the place is one in which location mobility receives more emphasis than space mobility, so that the desired information can be reconstructed and transferred to each user in conformity with the requirements and context of the user, and magazine information can be used as a means for transferring various types of information such as events or notice messages if necessary.

This scheme is advantageous in that limitations in dynamic reconstruction occurring in the transfer of a conventional magazine or information can be overcome, and in that costs resulting from a series of procedures such as information collection/editing/publication and costs attributable to the gap between times at which information is provided (the interval between collection and publication) are reduced, thus minimizing the subsidiary loss.

Further, the present invention forms sociality in real time using social magazines even among a plurality of users having no sociality via a social network service, and allows the users to participate in the sociality and distribute and share information, thus more easily providing a social network service to the users.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A method of providing social magazine information, the method being configured such that an apparatus operating in conjunction with at least one user terminal provides the social magazine information to the user terminal, the method comprising:
dynamically reconstructing a social magazine according to a context of a user of the user terminal;
providing customized information corresponding to the user terminal based on the reconstructed social magazine; and
forming a community among user terminals which share the reconstructed social magazine, and sharing social magazine information through the formed community.

2. The method of claim 1, wherein the social magazine corresponds to information transfer means that is provided to users depending on a location and a space of the users.

3. The method of claim 1, wherein the dynamically reconstructing the social magazine comprises:
determining a domain corresponding to a service that is to be provided to the user;
determining which one corresponds to the domain between location mobility and space mobility;
construct a classification system for location mobility or space mobility based on results of the determination;
configuring profiles for respective classes based on the classification system; and
examining the configured profiles using a preset examination procedure, and determining whether to reconstruct the classification system based on results of the examination.

4. The method of claim 3, wherein the constructing the classification system comprises:
forming a classification system for location mobility based on latitude and longitude using a Global Positioning System (GPS) by subdividing an area depending on latitude and longitude, or forming a classification system for location mobility based on addresses such as in area boundaries; and
forming a classification system for space mobility based on a purpose of a movement space.

5. The method of claim 3, wherein the profiles correspond to information that is provided to the user terminal via the social magazine and comprise components extracted depending on a location and a space.

6. The method of claim 1, wherein the providing the customized information comprises:
collecting a location of the user and domain information corresponding to the location of the user;
analyzing information denoted by a current location based on the location of the user and the domain information;
extracting profile information of the user and a classification system for location mobility or space mobility based on results of the analysis of the information denoted by the current location, and analyzing results of the extraction;
extracting social magazine information based on the results of the analysis, and processing the extracted social magazine information in a required format; and
revising the processed social magazine information in accordance with characteristics of the user terminal.

7. The method of claim 6, wherein the providing the customized information comprises:
determining events and notification information, such as notice messages, in addition to the social magazine information, and configuring the determined notification information in a format of push-type information; and
outputting the push-type information and the social magazine information to the user terminal via a web interface.

8. The method of claim 1, wherein the sharing the social magazine information comprises:
determining an area for a location and a space corresponding to a domain of the user terminal connected to the apparatus;
determining whether a community is present in the area for the location and the space; and
selecting a method of sharing the social magazine information depending on results of the determination of whether the community is present.

9. The method of claim 8, wherein the selecting the method of sharing the social magazine information comprises:
if the community is present, registering the user of the terminal connected to the apparatus as a member of the community;
activating services among users in a social network formed by registering the user as the member of the community;
sharing information, which is shared by activating the services among the users in the social network, via a temporary storage unit; and
exchanging the social magazine information among the users via the temporary storage unit.

10. The method of claim 8, wherein the selecting the method of sharing the social magazine information comprises:
if a community is not present, initially constructing a community;
determining whether to activate the initially constructed community;
if a specific storage unit is required upon activating the community, exchanging the social magazine information among the users via the specific storage unit; and
if the specific storage unit is not required upon activating the community, waiting for the user terminal of the user to access the community.

11. An apparatus for providing social magazine information, comprising:
a social magazine operation unit for operating a social magazine corresponding to information transfer means that is provided to each user depending on a location and a space;
a dynamic magazine reconstruction management unit for dynamically reconstructing the social magazine according to a context of a user terminal held by the user; and
a user relation information management unit for providing customized information corresponding to the user terminal based on the reconstructed social magazine or forming a community among user terminals who share the reconstructed social magazine, and sharing the social magazine information through the formed community.

12. The apparatus of claim 11, wherein the social magazine operation unit comprises:
a user interface reconstruction unit for reconstructing user interfaces corresponding to characteristics of user terminals held by respective users;
a web server engine unit for setting methods of connecting to the respective user terminals;
a user information management unit for managing pieces of user information corresponding to the user terminals;
a community management unit for extracting sociality among the user terminals, and forming and managing communities with the users through a community corresponding to the extracted sociality; and
a shared information management unit for supporting shared information transfer methods by which the respective users are capable of transferring their desired information using the communities.

13. The apparatus of claim 12, wherein each of the user terminals is means provided with a social network service and comprises feature elements related to hardware specifications.

14. The apparatus of claim 11, wherein the dynamic magazine reconstruction management unit comprises:
a storage unit for storing the social magazine information;
an extraction unit for extracting information about a service that is to be provided to each user based on location information, space information, and profile information corresponding to at least one of pieces of user information;
a processing unit for processing extracted service information in a format corresponding to the user terminal;
an editing unit for reconstructing processed service information in conformity with characteristics of the user terminal, and then generating the dynamic magazine information; and
a management unit for analyzing the dynamic magazine information and determining a service method to be subsequently provided, in relation to a context in which the dynamic magazine information is to be provided, based on results of the analysis.

15. The apparatus of claim 11, wherein the user relation information management unit comprises:
a user profile management unit for managing profiles of the user corresponding to the user terminal;
an information management unit for managing location and space information of the user corresponding to the user terminal in real time;
a social network construction unit for constructing network elements required to transfer information among users in the community; and
a dynamic community processing unit for performing control so that pieces of information provided through the community are shared via participation of the users in the community.
